(19) United States
(12) Patent Application Publication
(10) Pub. No.: US 2012/0294466 A1
(43) Pub. Date: Nov. 22, 2012

(54) TEMPORARY ANCHOR FOR A HEARING PROSTHESIS

(76) Inventors: Stefan Kristo, Goteborg (SE); Henrik Jeppesen, Holte (DK); Martin Praºme, Svedala (SE)

(21) Appl. No.: 13/110,754

(22) Filed: May 18, 2011

(51) Int. Cl. H04R 25/00

(52) U.S. Cl. 381/322

(57) ABSTRACT

A hearing system, comprising: an adhesive element adapted to temporarily adhere to the skin of a recipient; a hearing prosthesis having a coupler and an anchor having a first surface adapted to adhere to the adhesive element, and a fixture adapted to attach to the coupler of the hearing prosthesis.

### BACKGROUND

1. Field of the Invention

The present invention relates generally to hearing prostheses, and more particularly, to a temporary anchor for a hearing prosthesis.

2. Related Art

Hearing loss, which may be due to many different causes, is generally of two types: conductive and sensorineural. Sensorineural hearing loss is due to the absence or destruction of the hair cells in the cochlea that transduce sound signals into nerve impulses. Various hearing prostheses are commercially available to provide individuals suffering from sensorineural hearing loss with the ability to perceive sound. For example, cochlear implants use an electrode array implanted in the cochlea of a recipient to bypass the mechanisms of the ear. More specifically, an electrical stimulus is provided via the electrode array to the auditory nerve, thereby causing a hearing percept.

Conductive hearing loss occurs when the normal mechanical pathways that provide sound to hair cells in the cochlea are impeded, for example, by damage to the ossicular chain or ear canal. Individuals suffering from conductive hearing loss may retain some form of residual hearing because the hair cells in the cochlea may remain undamaged.

Individuals suffering from conductive hearing loss typically receive an acoustic hearing aid. Hearing aids rely on principles of air conduction to transmit acoustic signals to the cochlea. In particular, a hearing aid typically uses a component positioned in the recipient's ear canal or on the outer ear to amplify a sound received by the outer ear of the recipient. This amplified sound reaches the cochlea causing motion of the perilymph and stimulation of the auditory nerve.

In contrast to hearing aids, certain types of hearing prostheses, commonly referred to as bone conduction devices, convert a received sound into mechanical vibrations. The vibrations are transferred through the skull to the cochlea causing generation of nerve impulses, which result in the perception of the received sound. Bone conduction devices may be a suitable alternative for individuals who cannot derive sufficient benefit from acoustic hearing aids, cochlear implants, etc.

### SUMMARY

In accordance with one aspect of the present invention, a hearing system is provided. The system comprises: an adhesive element adapted to temporarily adhere to the skin of a recipient; a hearing prosthesis having a coupler and an anchor having a first surface adapted to adhere to the adhesive element, and a fixture adapted to attach to the coupler of the hearing prosthesis.

In accordance with another aspect of the present invention, a method for using a temporary anchor having a first surface adapted to adhere to the adhesive element, and a fixture adapted to attach to a coupler of the hearing prosthesis is provided. The method comprises: assembling the temporary anchor; removably affixing the temporary anchor to the skin of a recipient; and attaching the hearing prosthesis to the temporary anchor.

In accordance with another aspect of the present invention, a hearing prosthesis anchor is provided. The anchor comprises: a first surface adapted to adhere to an adhesive element temporarily on the skin of a recipient; and a fixture adapted to attach to a coupler of a hearing prosthesis.

### BRIEF DESCRIPTION OF THE DRAWINGS

Embodiments of the present invention are described below with reference to the attached drawings, in which:

FIG. 1 is a perspective view of an exemplary hearing prosthesis attached to a recipient via a temporary anchor in accordance with embodiments of the present invention;

FIG. 2A is a perspective view of an assembled temporary anchor, in accordance with embodiments of the present invention;

FIG. 2B is a perspective view of the temporary anchor of FIG. 2A in which the components have been separated from one another;

FIG. 2C is a cross-sectional view of the temporary anchor of FIG. 2A;

FIG. 3A is a perspective view of an assembled temporary anchor, in accordance with embodiments of the present invention;

FIG. 3B is a perspective view of the temporary anchor of FIG. 3A in which the components have been separated from one another;

FIG. 3C is a cross-sectional view of the temporary anchor of FIG. 3A;

FIG. 4A is a perspective view of an assembled temporary anchor, in accordance with embodiments of the present invention;

FIG. 4B is a perspective view of the temporary anchor of FIG. 4A in which the components have been separated from one another;

FIG. 4C is a cross-sectional view of the temporary anchor of FIG. 4A;

FIG. 5A is a perspective view of one type of adhesive element, in accordance with embodiments of the present invention;

FIG. 5B is a perspective view of one type of adhesive element, in accordance with embodiments of the present invention;

FIG. 6A is a flowchart illustrating a method for using a temporary anchor, in accordance with embodiments of the present invention;

FIG. 6B is a flowchart illustrating a method for assembling a temporary anchor, in accordance with embodiments of the present invention;

FIG. 6C is a flowchart illustrating a method for assembling a temporary anchor, in accordance with embodiments of the present invention; and

FIG. 6D is a flowchart illustrating a method for assembling a temporary anchor, in accordance with embodiments of the present invention.

### DETAILED DESCRIPTION

Aspects of the present invention are generally directed to a temporary anchor for a hearing prosthesis. The anchor is adapted to be affixed to a recipient's skin via an adhesive element, and comprises a fixture configured to attach to a coupler of a hearing prosthesis.

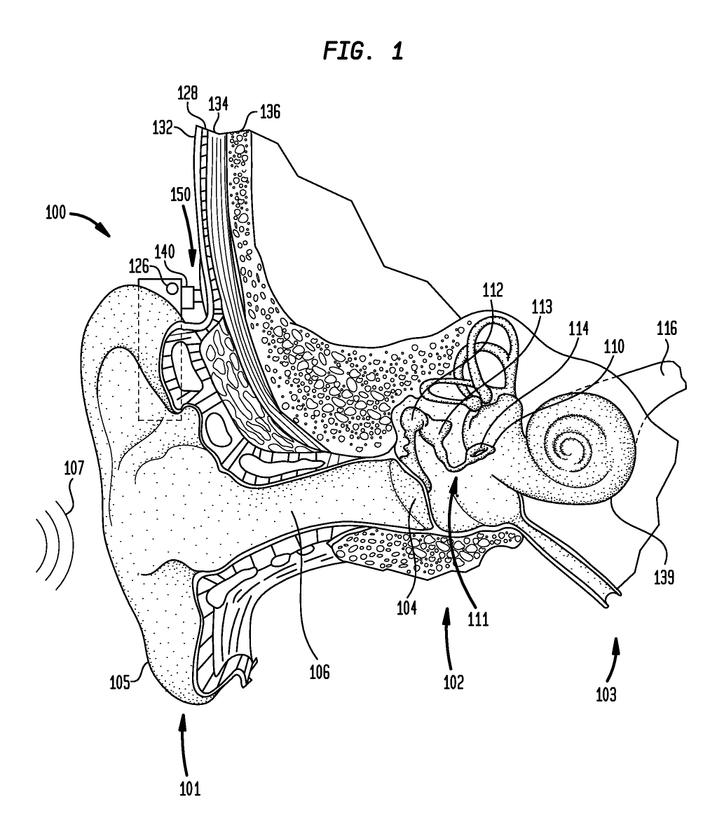

FIG. 1 is a perspective view of a conventional hearing prosthesis 100 having a coupling apparatus 140 attached to a temporary anchor 150, in accordance with embodiments of the present invention. As shown, the recipient has an outer ear 101, a middle ear 102 and an inner ear 103. Elements of outer ear 101, middle ear 102 and inner ear 103 are described below, followed by a description of hearing prosthesis 100.

In a fully functional human hearing anatomy, outer ear 101 comprises an auricle 105 and an ear canal 106. A sound wave or acoustic pressure 107 is collected by auricle 105 and channeled into and through ear canal 106. Disposed across the distal end of ear canal 106 is a tympanic membrane 104 which vibrates in response to acoustic wave 107. This vibration is coupled to oval window or fenestra ovalis 110 through three bones of middle ear 102, collectively referred to as the ossicles 111 and comprising the malleus 112, the incus 113 and the stapes 114. The ossicles 111 of middle ear 102 serve to filter and amplify acoustic wave 107, causing oval window 110 to vibrate. Such vibration sets up waves of fluid motion within cochlea 139. Such fluid motion, in turn, activates hair cells (not shown) that line the inside of cochlea 139. Activation of the hair cells causes appropriate nerve impulses to be transferred through the spiral ganglion cells and auditory nerve 116 to the brain (not shown), where they are perceived as sound.

FIG. 1 also illustrates the positioning of hearing prosthesis 100 relative to outer ear 101, middle ear 102 and inner ear 103 of a recipient of device 100. As shown, hearing prosthesis 100 is positioned behind outer ear 101 of the recipient and comprises a sound input element 126 to receive sound signals. Sound input element may comprise, for example, a microphone, telecoil, etc. In an exemplary embodiment, sound input element 126 may be located, for example, on or in hearing prosthesis 100, or on a cable extending from hearing prosthesis 100.

Also, hearing prosthesis 100 preferably comprises a bone conduction device, though other types of hearing prostheses are within the scope of the present invention. More specifically, hearing prosthesis 100 comprises a sound processor (not shown), a vibrating electromagnetic actuator and/or various other operational components. More particularly, sound input device 126 (e.g., a microphone) converts received sound signals into electrical signals. These electrical signals are processed by the sound processor. The sound processor generates control signals which cause the actuator to vibrate. In other words, the actuator converts the electrical signals into mechanical motion to impart vibrations to the recipient's skull.

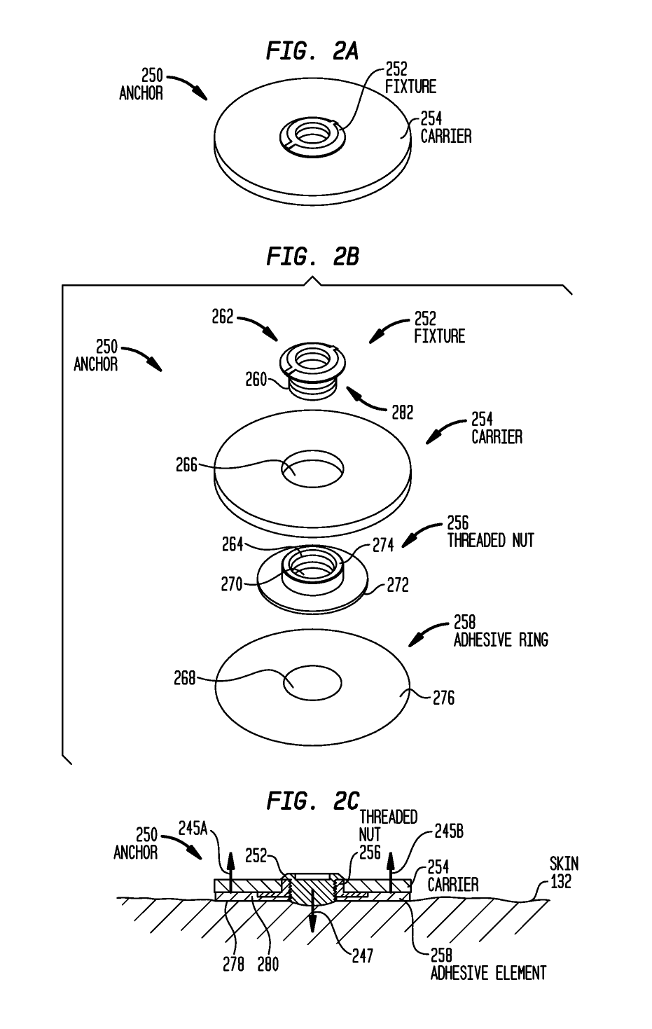

In the embodiments of FIG. 1, hearing prosthesis 100 further includes a coupler 140 configured to be attached to a temporary anchor 150. FIG. 2A is a perspective view of one embodiment of temporary anchor 150, shown as temporary anchor 250, adapted to be affixed to a recipient's skin via an adhesive element, and configured to attach to a coupler of a hearing prosthesis. FIG. 2B is an exploded view of anchor 250, while FIG. 2C is a cross-sectional view of the anchor.

Anchor 250 comprises a threaded nut 256 having an internally threaded portion 274 extending from a washer portion 272. As shown, disposed around threaded portion 274 is a ring-shaped carrier 254. Anchor 250 further comprises a fixture 252 having an attachment portion 262 and an externally threaded portion 282. Threaded portion 282 extends through opening 266 in carrier 254 such that external threads 260 mate with internal threads 264 of nut 256.

As shown in FIG. 2C, an adhesive element 258 is positioned between anchor 250 and the recipient's skin 132. As described further below, adhesive element 258 may be selected from a number of different adhesive materials having different configurations. In this illustrative embodiment, adhesive element 258 is a double-sided adhesive film having a ring shape. That is, adhesive ring 258 has a generally circular shape and has an opening 268 at the center thereof. Lower surface 280 of carrier 254 is configured to firmly adhere to top surface 276 of adhesive ring 258.

During use, fixture 252 is screwed into threaded nut 256 in the direction of arrow 247, and, as a result, carrier 254 is pulled away from the recipient's skin in the direction of arrows 245. However, adhesive element 258 prevents the carrier from detaching from the skin, thereby resulting in a pressure from fixture 252 on the recipient's skin and skull. The position of fixture 252 relative to carrier 254, and thus the applied pressure, is adjustable by screwing fixture 256 into or out of threaded nut 256. As such, temporary anchor 250 is sometimes referred to herein as a pressure adjustable anchor.

As noted above, fixture 252 also comprises an attachment portion 262 adapted to mechanically mate with a coupler of a hearing prosthesis. In certain embodiments, attachment portion 262 is configured to attach to a conventional coupler and, as such, a coupler may snap, screw or twist onto attachment portion 262. As would be appreciated, different types of couplers may be used for different hearing prostheses, and, as such, fixtures having attachment portions of different shapes, sizes, etc., for attachment to these different couplers are within the scope of the present invention. For example, in certain hearing prostheses, a mechanical coupler is replaced with a magnet in the device. In such an arrangement, the attachment portion 262 of fixture 252 is a magnetic material of sufficient size to magnetically couple to the magnet within the hearing prosthesis.

As shown in FIG. 2C, the distal end of fixture 252 extends through openings 270 and 268 of nut 256 and adhesive ring 258, respectively, to abut the recipient's skin 132. Accordingly, when a hearing prosthesis is attached to anchor 250, fixture 252 provides a vibratory pathway for the mechanical vibrations. That is, vibration from the hearing prosthesis is transferred through fixture 252 and skin 132 to the recipient's skull so as to evoke a hearing perception.

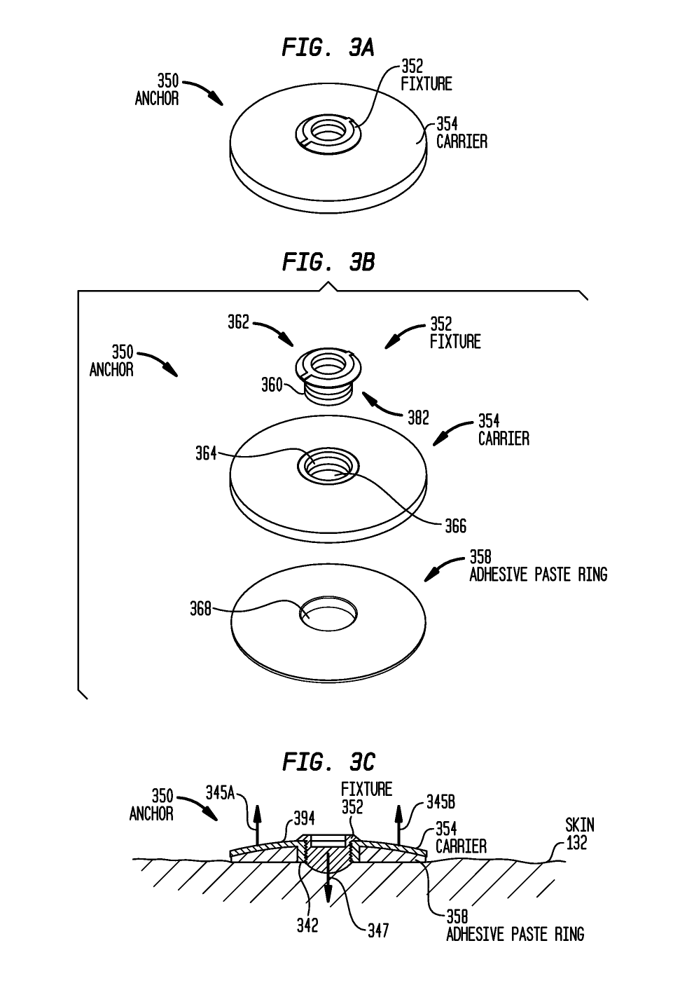

FIG. 3A is a perspective view of another embodiment of temporary anchor 150, shown as temporary anchor 350, adapted to be affixed a recipient's skin via an adhesive element, and configured to attach to a coupler of a hearing prosthesis. FIG. 3B is an exploded view of anchor 350, while FIG. 3C is a cross-sectional view of the anchor.

In contrast to the embodiments of FIGS. 2A-2C, anchor 350 does not include a threaded nut adapted to mate with a fixture. Rather, in these embodiments, carrier 354 includes internal threads 364. Anchor 350 further comprises a fixture 352 have an attachment portion 362 and a threaded portion 382 having external threads 360. Threaded portion 382 extends through opening 366 in carrier 354 such that external threads 360 mate with internal threads 364.

As shown in FIG. 3C, an adhesive element 358 is positioned between anchor 350 and the recipient's skin 132. As described further below, adhesive element 358 may be selected from a number of different adhesive materials having different configurations. In this illustrative embodiment, adhesive element 358 is an adhesive paste 358. Carrier 354 has internal threaded wall 392 and an upper wall 394 forming a generally concave area that receives adhesive element 358 therein. In the arrangements of FIGS. 3A-3C, adhesive element 358 is an adhesive paste formed into a ring shape, and adapted to substantially fill the concave region formed by walls 392, 394.

During use, fixture 352 is screwed into threaded carrier member 354 in the direction of arrow 347, and, as a result, carrier 354 is pulled away from the recipient's skin in the direction of arrows 345. However, adhesive paste ring 358 prevents the carrier from detaching from the skin, thereby resulting in a pressure from fixture 352 on the recipient's skin and skull. The position of fixture 352 relative to carrier 354, and thus the applied pressure, is adjustable by screwing fixture 356 into or out of internal threads 364. As such, temporary anchor 350 is sometimes referred to herein as a pressure adjustable anchor.

As noted above, fixture 352 also comprises an attachment portion 362 adapted to mechanically mate with a coupler of a hearing prosthesis. Similar to the embodiments described above with reference to FIGS. 2A-2C, attachment portion 362 is configured to attach to a conventional coupler. Also similar to the embodiments described above, different types of couplers may be used for different hearing prostheses, and, as such, fixtures having attachment portions of different shapes, sizes, etc., for attachment to these different couplers are within the scope of the present invention.

As shown in FIG. 3C, the distal end of fixture 352 extends through opening 366 and 368 of carrier 354 and adhesive paste ring 358, respectively, to abut the recipient's skin 132. Accordingly, when a hearing prosthesis is attached to anchor 350, fixture 352 provides a vibratory pathway for the mechanical vibrations. That is, vibration from the hearing prosthesis is transferred through fixture 352 and skin 132 to the recipient's skull so as to evoke a hearing perception.

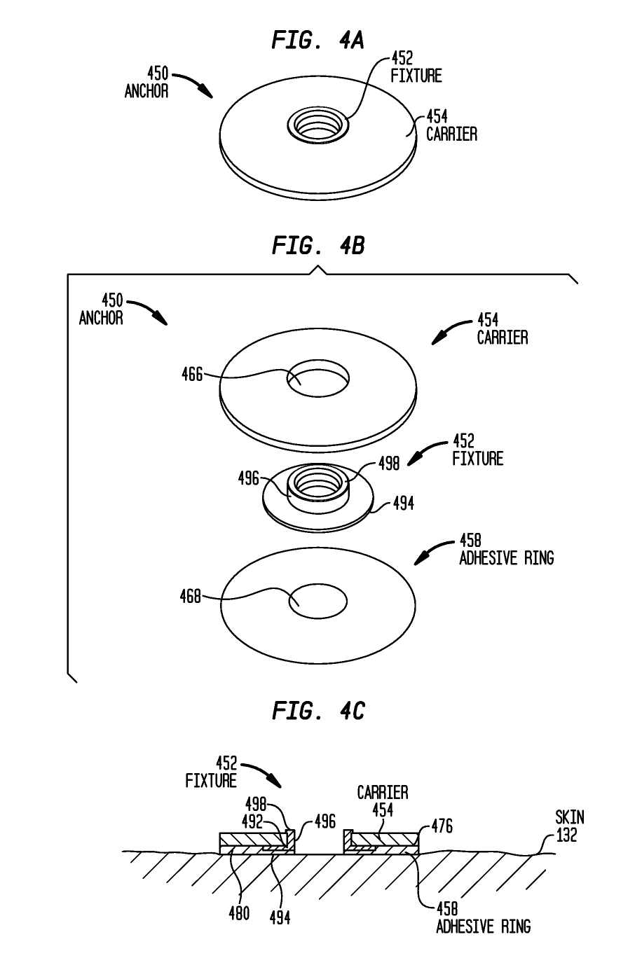

FIG. 4A is a perspective view of another embodiment of temporary anchor 150, shown as temporary anchor 450, adapted to be affixed directly to a recipient's skin and configured to attach to a coupler of a hearing prosthesis. FIG. 4B is an exploded view of anchor 350, while FIG. 4C is a cross-sectional view of the anchor.

As shown, anchor 450 comprises a ring shaped carrier 454 having a opening 466 therein. Anchor 450 further comprises a fixture 452 having a substantially planar region 494 and a tubular shaped region 496 extending from the lower region. Disposed on the end of tubular region 496 is upper ring-shaped attachment region 498 that extends over the outer edge of region 496. As such, regions 494, 496 and 498 collectively form a circumferentially extending concave region 492. Carrier member 454 is sized and shaped such that the regions 496, 498 of fixture 452 are inserted into opening 466, and such that the inner surfaces of the carrier adjacent opening 466 engage with fixture 452 in a snap-lock arrangement.

As shown in FIG. 4C, an adhesive element 458 is positioned between anchor 450 and the recipient's skin 132. As described further below, adhesive element 458 may be selected from a number of different adhesive materials having different configurations. In this illustrative embodiment, adhesive element 458 is a double-sided adhesive film having a ring shape. That is, adhesive ring 458 has a generally circular shape and has an opening 468 at the center thereof. Lower surface 480 of carrier 454 is configured to firmly adhere to top surface 476 of adhesive ring 458.

During use, as fixture 452 is screwed into threaded carrier member 454, a force is exerted on carrier 454. This force causes carrier 454, and particularly wall 494, to adhere, and remain adhered to, adhesive paste ring 458.

As noted above, fixture 452 also comprises an upper region 498. This upper region 498 is adapted to mechanically mate with a coupler of a hearing prosthesis. Similar to the embodiments described above with reference to FIGS. 2A-2C and FIGS. 3A-3C, upper region 498 is configured to attach to a conventional coupler. Also similar to the embodiments described above, different types of couplers may be used for different hearing prostheses, and, as such, fixtures having upper regions of different shapes, sizes, etc., for attachment to these different couplers are within the scope of the present invention.

As shown in FIG. 4C, region 494 of fixture 452 extends through opening 468 of adhesive ring 458, respectively, to abut the recipient's skin 132. Accordingly, when a hearing prosthesis is attached to anchor 450, fixture 452 provides a vibratory pathway for the mechanical vibrations. That is, vibration from the hearing prosthesis is transferred through fixture 452 and skin 132 to the recipient's skull so as to evoke a hearing perception.

FIGS. 2A-2C, 3A-3C, and 4A-4C illustrate three temporary anchors in accordance with embodiments of the present invention. It would be appreciated that these embodiments are not mutually exclusive, but rather have variations that may be combined in further embodiments. For example, temporary anchors 250, 450 of FIGS. 2A-2C and 4A-4C, respectively, were described as using a double-sided adhesive film ring. In one alternative variation, the rings 258, 458 may be replaced with the adhesive paste of FIGS. 3A-3C. In such an embodiment, carriers 254, 454 may have a similar shape as carrier 354 in that the open region for the paste may be provided, depending on the type of paste used.

In another variation, temporary anchor 350 of FIGS. 3A-3C could be designed to be affixed to the recipient via an adhesive film, such as adhesive ring 258 of FIGS. 2A-2C. In such embodiments, the open region for the paste would not be provided in carrier 354. Alternatively, temporary anchor 350 could be affixed using an adhesive paste that is applied via, for example, a brush as a thin film. Again, in such embodiments, the open region for the paste would not be provided in carrier 354. This type of thin film paste may also be used in the embodiments of FIGS. 2A-2C, and 4A-4C.

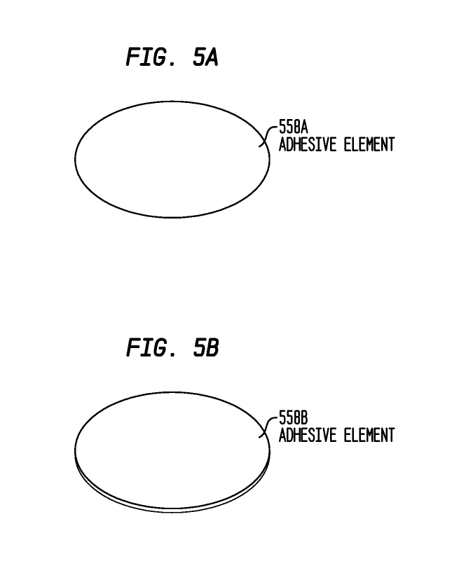

FIGS. 5A and 5B illustrate alternative embodiments in which adhesive elements 558 do not include an opening in the center thereof, but rather form generally circular shaped patches. Adhesive element 558A is a double-sided temporary adhesive film, while adhesive element 558B is a circular-shaped region of adhesive paste.

As noted above, temporary anchors in accordance with embodiments of the present invention are temporarily or removably affixed to a recipient's skin via an adhesive element. As used herein, removably affixed means that the anchor is affixed using an adhesive element that is a non-permanent adhesive designed to form a temporary bond with the skin. The bond may last for several hours, a day, several days, or several weeks, depending on the desired configuration.

As previously noted, a number of different types and configurations of adhesive elements now known or later develop may be used in embodiments of the preset invention. In certain embodiments, an adhesive film used in embodiments of the present invention may have adhesion properties similar to the adhesive used in Mepore® Film from Molnlycke® Healthcare US, LLC, Norcross, Ga., or the adhesive used in Compeed® Hydrocolloid patches from Johnson and Johnson, New Brunswick, N.J. In other embodiments, adhesive pastes used in embodiments of may have adhesive properties similar to ostomy adhesives used to retain a colostomy bag, urinary pouch, or other ostomy pouching system.

In further embodiments of the present invention, reusable dry adhesives may be used in embodiments. One exemplary dry adhesive that may be used in embodiments of the present invention mimics the toe hairs of a gecko and includes millions of nano structures that adhere to a surface. For example, one specific dry adhesive includes 42 million microfibers per square centimeter, and each microfiber is approximately 20 microns in length and has a diameter of less than 0.6 microns. In still other embodiments, adhesive elements that rely on vacuum or capillary forces to adhere to a surface may be used.

The adhesion of the adhesive element is such that it does not damage the skin, and such that it is sufficient to support the weight of the anchor and the hearing prosthesis, even as it vibrates. The adhesion of the adhesive element, and the amount of weight that may supported thereby, is a function of the material properties of the element, as well as the size of the contact areas between the skin/adhesive and adhesive/anchor. As such, in embodiments of the present invention, the surface area of the anchor that is adjacent to the adhesive is large enough so that sufficient adhesive is in contact with the skin and the anchor. Additionally, although a large surface area is desired, limitations to the size, shape, etc., arise due to use of the adhesive element on the head. Specifically, the temporary anchor is affixed behind the ear where available skin area is limited. Furthermore, the size of the adhesive element and anchor should be small enough so as to be unobtrusive and as unnoticeable as possible. As would be appreciated, the size of the adhesive element and anchor that provides sufficient adhesion may vary depending on the adhesive element used.

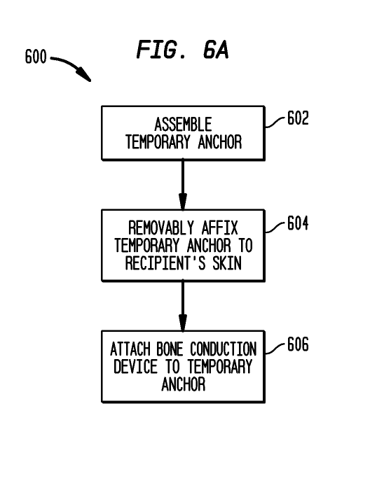

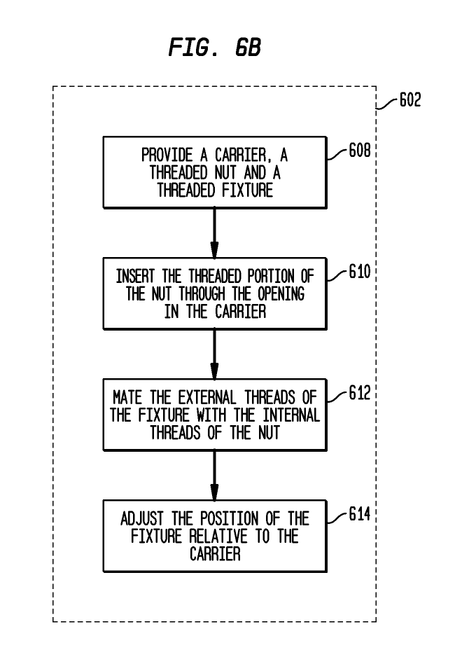

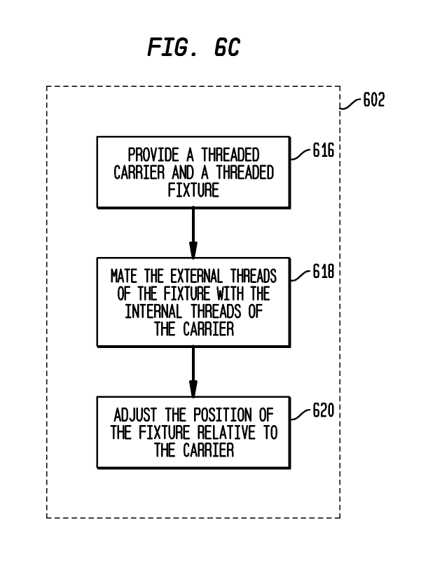

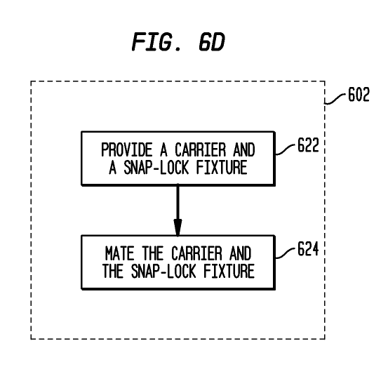

FIG. 6A is a high-level flowchart illustrating an exemplary method 600 for use of a temporary anchor in accordance with embodiments of the present invention. Method 600 begins at step 602 where the anchor is assembled. Exemplary methods for assembling the anchor are described below with reference to FIGS. 6B-6D. Method 600 continues at step 604 where the temporary anchor is removably affixed to a recipient's skin using any of the adhesive elements described above. The anchor is generally affixed behind the recipient's ear as shown in FIG. 1. Method 600 ends at step 606 where a hearing prosthesis is attached to the temporary anchor. It would be appreciated that, in certain embodiments, the hearing prosthesis may be attached to the anchor before it is affixed to the recipient's skin. As such, the order of steps 604 and 606 of FIG. 6A are merely illustrative.

As noted above, FIG. 6B illustrates one exemplary method for assembling a temporary anchor of step 602 of method 600. In this example, the temporary anchor has the configuration as described above with reference to FIGS. 2A-2C, including a threaded nut 256, carrier 254 and threaded fixture 252, all of which are provided at step 608. At step 610, the threaded region 274 of nut 256 is inserted into opening 266 of carrier 254 such that the upper surface of washer portion 272 abuts the lower surface of carrier 254. Next at step 612, the external threads 260 of fixture 252 are mated with the internal threads 264 of nut 246. Finally, at step 614 the position of fixture 252 relative to carrier 254 is adjusted by screwing fixture 252 into, or out of, nut 264.

FIG. 6C illustrates another exemplary method for assembling a temporary anchor of step 602 of method 600. In this example, the temporary anchor has the configuration as described above with reference to FIGS. 3A-3C, including a threaded carrier 354 and threaded fixture 352, both of which are provided at step 616. At step 618, the external threads 360 of fixture 352 are mated with the internal threads 364 of carrier 354. Finally, at step 620 the position of fixture 352 relative to carrier 354 is adjusted by screwing the fixture into, or out of, the carrier.

FIG. 6D illustrates another exemplary method for assembling a temporary anchor of step 602 of method 600. In this example, the temporary anchor has the configuration as described above with reference to FIGS. 4A-4C, including a carrier 454 and snap-lock fixture 452, both of which are provided at step 622. At step 624, snap-lock fixture 452 is mated with carrier 454.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A hearing system, comprising:
an adhesive element adapted to temporarily adhere to the skin of a recipient;
a hearing prosthesis having a coupler; and
an anchor having a first surface adapted to adhere to the adhesive element, and a fixture adapted to attach to the coupler of the hearing prosthesis.

2. The system of claim 1, wherein the anchor comprises:
a nut having a threaded portion extending from a substantially planar washer portion; and
a carrier circumferentially extending around the nut and having a first surface adapted to adhere to the adhesive element,
wherein the fixture has an attachment portion adapted to mate with the coupler and an external threaded portion extending from the attachment portion adapted to mate with the threads of the nut.

3. The system of claim 2, wherein the adhesive element is an adhesive film, and wherein the first surface of the carrier is substantially planar so as to adhere to the adhesive film.

4. The system of claim 2, wherein the adhesive element is an adhesive paste, and wherein the carrier has a concave region at the first surface that receives the paste.

5. The system of claim 1, wherein the anchor comprises:
a carrier having an internally threaded aperture, and a first surface adapted to adhere to the adhesive element, and
wherein the fixture has an attachment portion adapted to mate with the coupler and an external threaded portion extending from the attachment portion adapted to mate with the threads of the carrier.

6. The system of claim 5, wherein the adhesive element is an adhesive film, and wherein the first surface of the carrier is substantially planar so as to adhere to the adhesive film.

7. The system of claim 5, wherein the adhesive element is an adhesive paste, and wherein the carrier has a concave region at the first surface that receives the paste therein.

8. The system of claim 1, wherein the anchor comprises:
a carrier having opposing first and second surfaces and an aperture extending there through, and
wherein the fixture is a snap-lock fixture including:
a substantially planar lower region adjacent the first surface,
a tubular shaped region extending from the lower region through the aperture,
and an upper ring-shaped region extending over the outer edge of the tubular region at the second surface,
wherein the regions of the fixture collectively form a circumferentially extending concave region that mates with the carrier in a snap-lock arrangement.

9. The system of claim 8, wherein the adhesive element is an adhesive film, and wherein the first surface of the carrier is substantially planar so as to adhere to the adhesive film.

10. The system of claim 8, wherein the adhesive element is an adhesive paste, and wherein the carrier has a concave region at the first surface that receives the paste therein.

11. The system of claim 1, wherein the fixture configured to mechanically mate with the coupler.

12. The system of claim 1, wherein the coupler of the hearing prosthesis is a magnet, and wherein the fixture is configured to magnetically couple to the magnet.

13. A method for using a temporary anchor having a first surface adapted to adhere to the adhesive element, and a fixture adapted to attach to a coupler of a hearing prosthesis, comprising:
assembling the temporary anchor;
removably affixing the temporary anchor to the skin of a recipient; and
attaching the hearing prosthesis to the temporary anchor.

14. The method of claim 13, wherein removably affixing the temporary anchor to the skin of the recipient comprises:
placing an adhesive element on the skin of the recipient;
adhering the anchor to the adhesive element.

15. The method of claim 13, wherein the temporary anchor comprises a nut having a threaded portion extending from a substantially planar washer portion, a carrier having an aperture extending there through, and wherein the fixture has an attachment portion adapted to mate with the coupler and an external threaded portion extending from the attachment portion, wherein assembling the temporary anchor comprises:
inserting the nut through the aperture in the carrier;
mating the external threads of the fixture with the threads of the nut; and
adjusting the position of the fixture relative to the carrier.

16. The method of claim 13, wherein the temporary anchor comprises a carrier having internal threads, and wherein the fixture has an attachment portion adapted to mate with the coupler and an external threaded portion extending from the attachment portion, wherein assembling the temporary anchor comprises:
mating the external threads of the fixture with the internal threads of the carrier; and
adjusting the position of the fixture relative to the carrier.

17. The method of claim 13, wherein the temporary anchor comprises a carrier having first and second opposing surfaces, and an aperture extending there through, and wherein the fixture is a snap-lock fixture having a substantially planar lower region, a tubular shaped region extending from the lower region, and an upper ring-shaped region, wherein assembling the temporary anchor comprises:
inserting the tubular and upper regions of the fixture through the aperture such that the fixture and carrier mate in a snap-lock arrangement.

18. A hearing prosthesis anchor, comprising:
a first surface adapted to adhere to an adhesive element temporarily on the skin of a recipient; and
a fixture adapted to attach to a coupler of a hearing prosthesis.

19. The anchor of claim 18, further comprising:
a nut having an threaded portion extending from a substantially planar washer portion; and
a carrier circumferentially extending around the threaded portion of the nut and having a first surface adapted to adhere to the adhesive element,
wherein the fixture has an attachment portion adapted to mate with the coupler and an external threaded portion extending from the attachment portion adapted to mate with the internal threaded portion such that the attachment portion of the fixture is adjacent the carrier.

20. The anchor of claim 19, wherein the adhesive element is an adhesive film, and wherein the first surface of the carrier is substantially planar so as to adhere to the adhesive film.

21. The anchor of claim 19, wherein the adhesive element is an adhesive paste, and wherein the carrier has a concave region at the first surface that receives the paste.

22. The anchor of claim 18, further comprising:
a carrier having an internally threaded aperture, and a first surface adapted to adhere to the adhesive element, and
wherein the fixture has an attachment portion adapted to mate with the coupler and an external threaded portion extending from the attachment portion adapted to mate with the threads of the carrier.

23. The anchor of claim 22, wherein the adhesive element is an adhesive film, and wherein the first surface of the carrier is substantially planar so as to adhere to the adhesive film.

24. The anchor of claim 22, wherein the adhesive element is an adhesive paste, and wherein the carrier has a concave region at the first surface that receives the paste therein.

25. The anchor of claim 18, further comprising:
a carrier having opposing first and second surfaces and an aperture extending there through, and
wherein the fixture is a snap-lock fixture including:
a substantially planar lower region adjacent the first surface,
a tubular shaped region extending from the lower region through the aperture,
and an upper ring-shaped region extending over the outer edge of the tubular region at the second surface,
wherein the regions of the fixture collectively form a circumferentially extending concave region that mates with the carrier in a snap-lock arrangement.

26. The anchor of claim 25, wherein the adhesive element is an adhesive film, and wherein the first surface of the carrier is substantially planar so as to adhere to the adhesive film.

27. The anchor of claim 25, wherein the adhesive element is an adhesive paste, and wherein the carrier has a concave region at the first surface that receives the paste therein.

28. The anchor of claim 18, wherein the fixture configured to mechanically mate with the coupler.

29. The anchor of claim 18, wherein the coupler of the hearing prosthesis is a magnet, and wherein the fixture is configured to magnetically couple to the magnet.

30. The system of claim 1, wherein the hearing prosthesis comprises a bone conduction device.
